(19) United States
(12) Patent Application Publication
(10) Pub. No.: US 2016/0030135 A1
(43) Pub. Date: Feb. 4, 2016

(54) DRILL BIT GUIDING DEVICE FOR DENTAL IMPLANT SURGERY

(71) Applicant: En-Heng Liu, Taipei City (TW)

(72) Inventor: En-Heng Liu, Taipei City (TW)

(21) Appl. No.: 14/445,075

(22) Filed: Jul. 29, 2014

(51) Int. Cl. A61C 1/08

(52) U.S. Cl. CPC A61C 1/084

(57) ABSTRACT

A drill bit guiding device for dental implant surgery comprises a dental implant platform positioning ruler, a connecting fixing member and a drill bit guide. The dental implant platform positioning ruler is used to configure an ideal dental implant placement position on a tooth model.

Then, the connecting fixing member is embedded into the dental implant platform positioning ruler, and a resin material connects extensions of the connecting fixing member to neighboring teeth on two sides of the dental implant position. Finally, the connecting fixing member and the resin material are removed and placed on an oral gum to be treated.

Meanwhile, the drill bit guide is inserted into the connecting fixing member, so that a hole satisfying the ideal dental implant position and angle is drilled at the planned dental implant position through a through hole of the drill bit guide.

### BACKGROUND OF THE INVENTION

1. Field of the Invention

The invention relates to a drill bit guiding device for dental implant surgeries, and more particularly to a device capable of facilitating the layout of dental implant position and angle.

2. Description of the Prior Art

Typically, the aesthetic implant treatment in the maxillary anterior region is more difficult because two portions of the alveolar bone hard tissue and the gum soft tissue have to be considered, the alveolar bones in the anterior region are in most cases inclined, and the angle in the drilling process tends to skew. In addition, the position of the implant body platform directly affects the future position of the buccal side gingival edge. According to the related literature, to achieve long-term stability of aesthetic treatment, the buccal side of the implant body platform needs to have bone with thickness of 2 mm. At this time, the gum edge is present at 3 to 4 mm position of the implant body platform in the tooth cut-side. Under the restrictions of the patient's mouth open size and the operator's view angle, it is considerably difficult to place the artificial toothroot to the ideal position without an auxiliary tool. Generally speaking, the alveolar bone buccal side portion in the edentulous region has a lower bone density, the absorption tends to occur compared to the palatal side (lingual side), and the condition that the dental ridge shape of the edentulous region has the inclined shape from the high buccal side of the palatal side to the low dental ridge is often observed. In addition, the buccal side and the palatal side (lingual side) of the bone in the edentulous region have different thicknesses of cortical bones, and the offset to the softer buccal side tends to occur in the drilling process or in the screwing process of the implant body. At present, the dental implant surgical stents in the clinical condition are classified into two types. In the first type, the dental technician firstly reconstructs the ideal tooth pattern of the edentulous region on the plaster model, and then a circular hole is drilled at the center of the simulated tooth occlusal surface to serve as a reference implant path upon surgery. In the second type, the jawbone tomography has to be performed, and the computer software is utilized to establish the virtual positioning plate on the stereoscopic image. Then, the computer aided manufacturing technology is adopted to manufacture a physical surgery positioning template, which assists the dentist to prevent the overturn and offset from occurring upon drilling on the alveolar bone, and can enhance the initial stability upon artificial tooth implanting. However, the manufacturing of the two types of surgery templates needs the cooperation of the technician and numerous communications back and forth, and most importantly has a higher manufacturing cost.

The main object of this invention is to solve the above-mentioned problems.

### SUMMARY OF THE INVENTION

A main object of the invention is to provide a drill bit guiding device for dental implant surgery. The drill bit guiding device comprises a dental implant platform positioning ruler, a connecting fixing member and a drill bit guide. The dental implant platform positioning ruler is used to configure an ideal dental implant placement position on a tooth model. Then, the connecting fixing member is embedded into the dental implant platform positioning ruler, and a resin material connects extensions of the connecting fixing member to neighboring teeth on two sides of the dental implant position. Finally, the connecting fixing member and the resin material are removed and placed on an oral gum to be treated. Meanwhile, the drill bit guide is inserted into the connecting fixing member, so that a hole satisfying the ideal dental implant position and angle is drilled at the planned dental implant position through a hole of the drill bit guide.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a pictorial view showing the invention.

FIG. 2 is a pictorially exploded view showing the invention.

FIGS. 3 to 9 are several views showing the preferred embodiment of the invention.

FIG. 10 shows another embodiment of the invention.

### DETAILED DESCRIPTION OF THE PREFERRED EMBODIMENTS

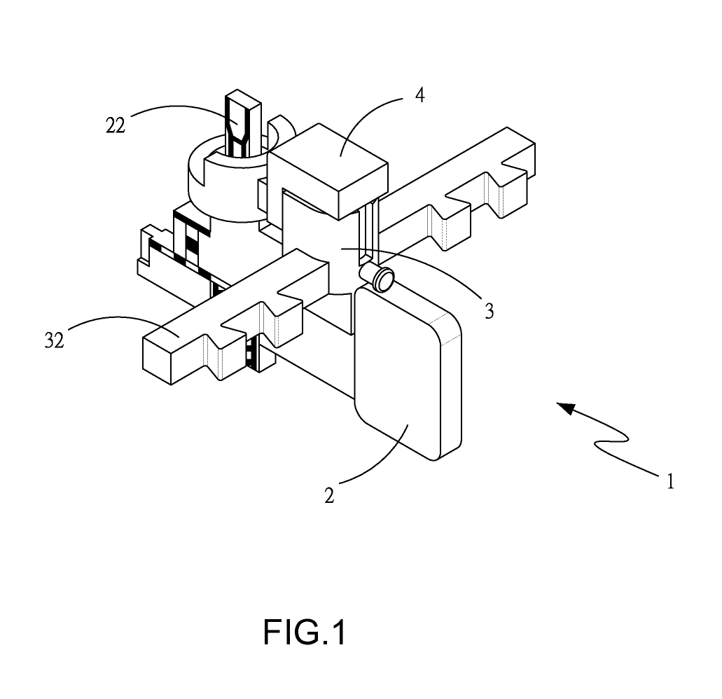

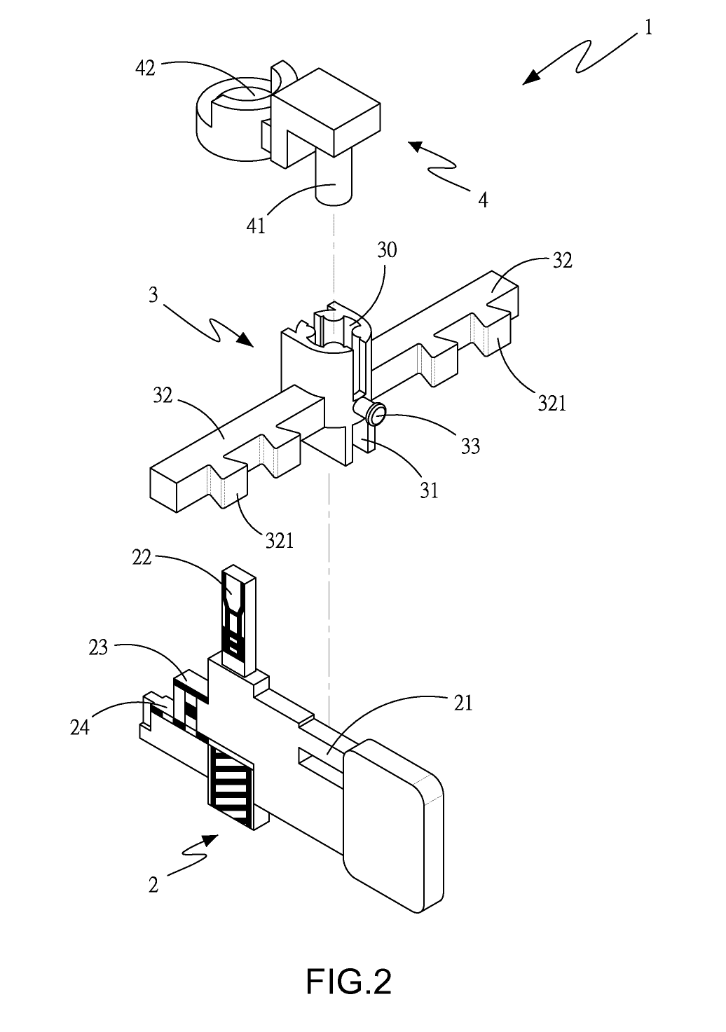

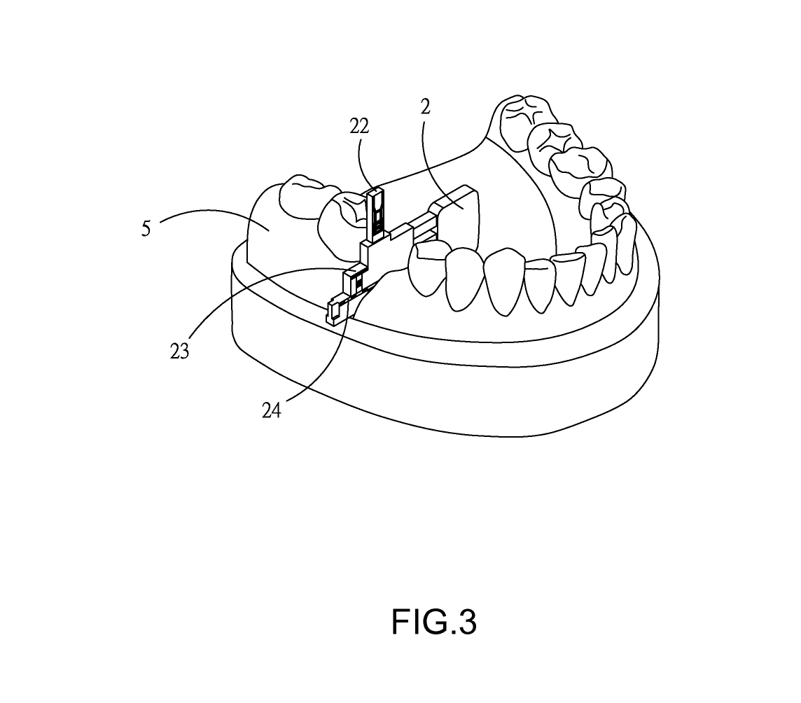

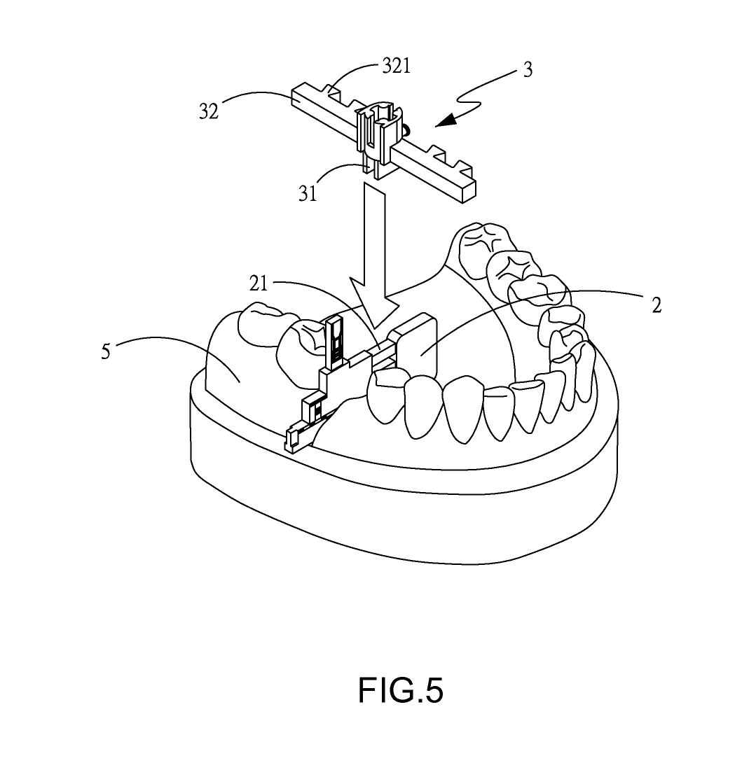

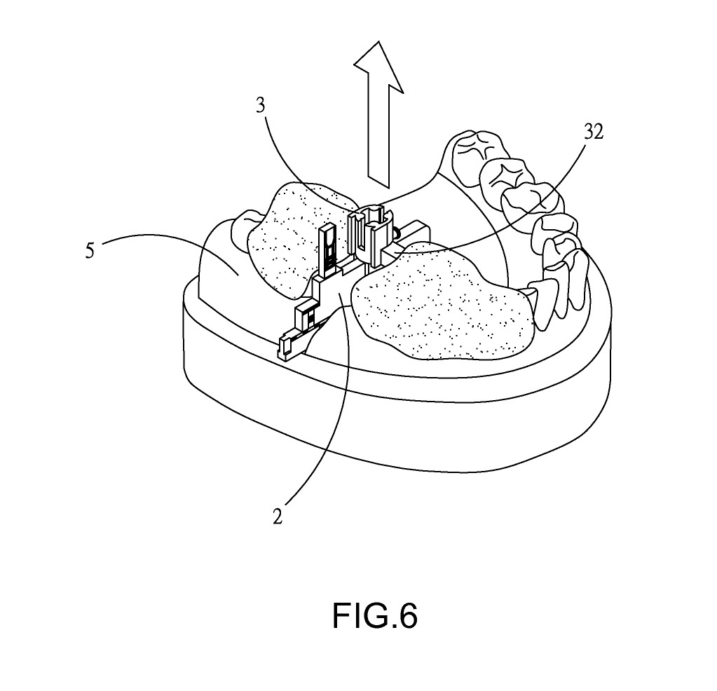

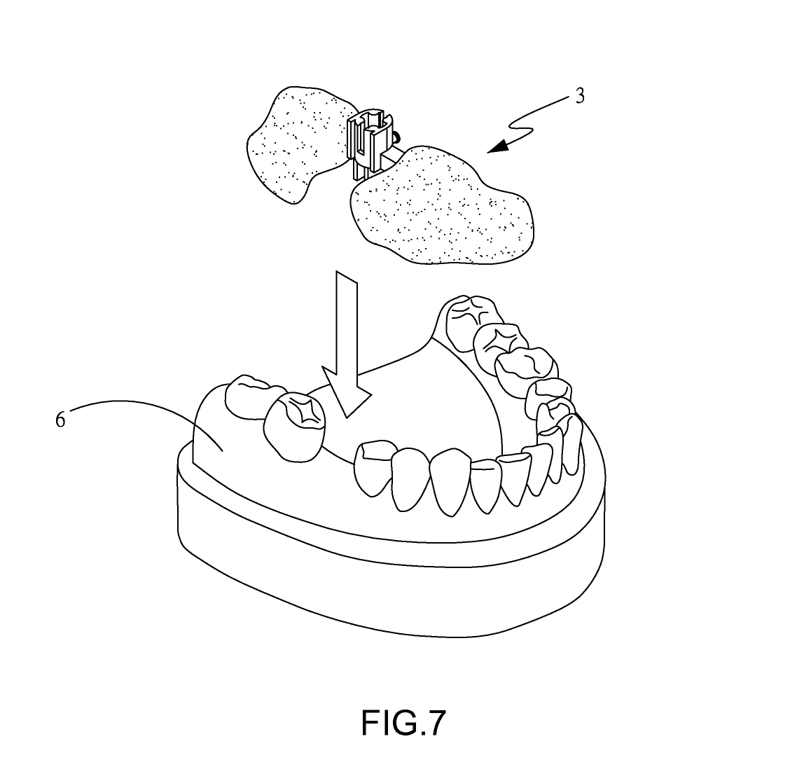

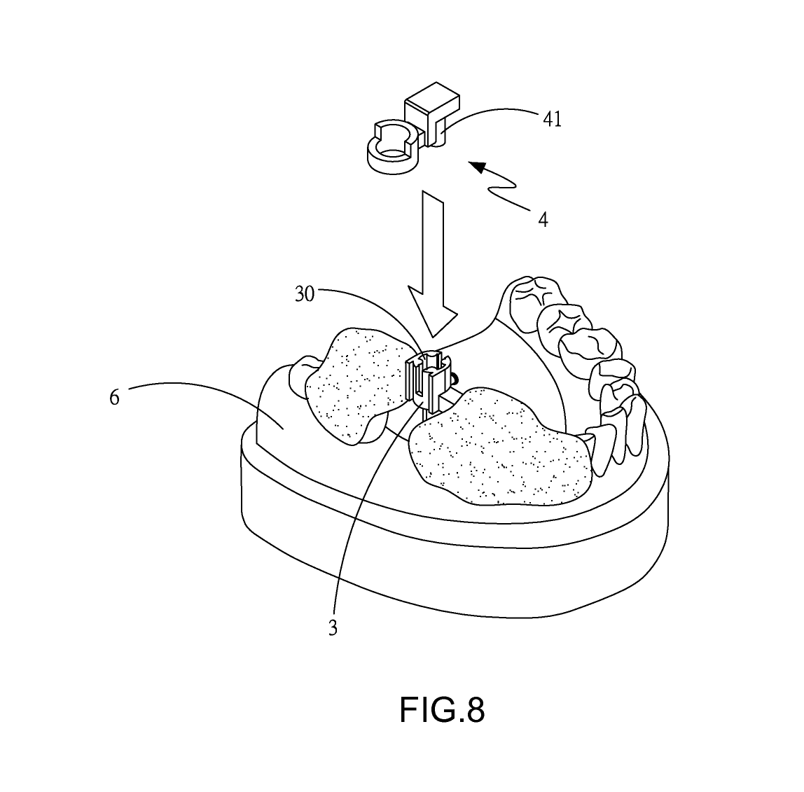

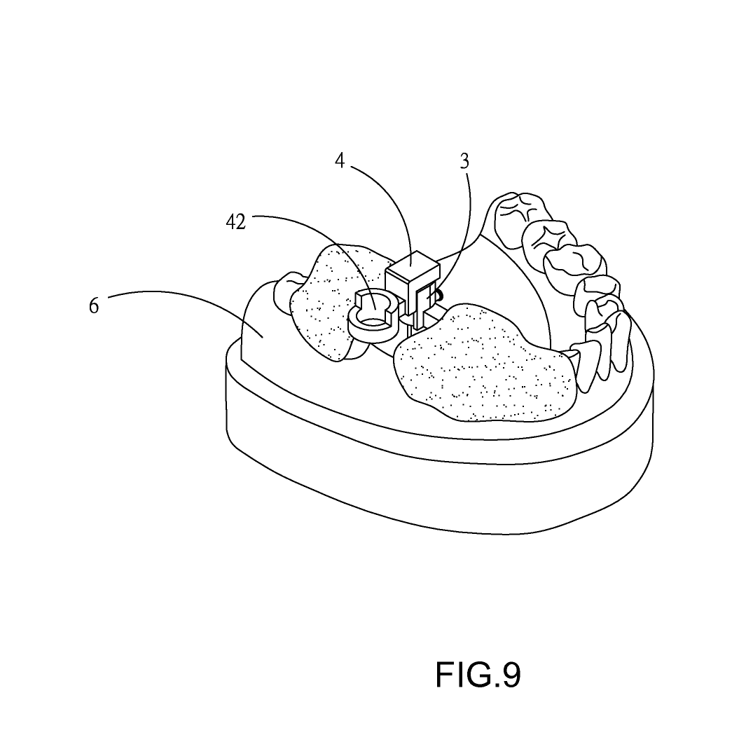

FIGS. 1 to 10 show a pictorial view, a pictorially exploded view, views of the preferred embodiment, and a view of another embodiment of the invention. Referring to FIGS. 1 to 10, the drill bit guiding device 1 for dental implant surgery comprises a dental implant platform positioning ruler 2, a connecting fixing member 3 and a drill bit guide 4.

The dental implant platform positioning ruler 2 has a fixing portion 21 and a protrusion 22, and additionally has a vertical reference portion 23 and a horizontal reference portion 24.

The connecting fixing member 3 has a slot 30. The other end of the slot 30 is formed with an insertion portion 31. The two corresponding sides of the connecting fixing member 3 are formed with a plurality of extensions 32 on which fixing protrusions 321 are disposed. The connecting fixing member 3 is embedded onto the fixing portion 21 of the dental implant platform positioning ruler 2 through the insertion portion 31. In addition, a grip portion 33 is disposed on an outer side of the slot 30.

The drill bit guide 4 has a projecting member 41 and a through hole 42 with a three-quarter scaled cylindrical structure. The drill bit guide 4 can be inserted into the slot 30 of the connecting fixing member 3 through the projecting member 41.

The invention mainly uses the vertical reference portion 23 and the horizontal reference portion 24 of the dental implant platform positioning ruler 2 to measure and configure an ideal dental implant position and angle on a tooth model 5, and to confirm that the dental implant platform is in a horizontal space, which is ideally 3 mm below the buccal gingival edge and 3˜4 mm away from an outer side of the buccal side gum. The connecting fixing member 3 is embedded into the fixing portion 21 of the dental implant platform positioning ruler 2 through the insertion portion 31, and then connects the extensions 32 of the connecting fixing member 3 to the neighboring teeth on two sides of the dental implant position through a resin material. Thereafter, the connecting fixing member 3 and the resin material can be removed from the tooth model 5 at the same time, and the projecting member 41 of the drill bit guide 4 is inserted into the slot 30 of the connecting fixing member 3, so that the assembly can be placed on an oral gum 6 to be treated in patient's mouth, and a hole satisfying the dental implant position and angle can be drilled at the planned dental implant position through the through hole 42 of the drill bit guide 4. Consequently, the dental implant platform overturns to the previously planned dental implant position when the dental implant is screwed in.

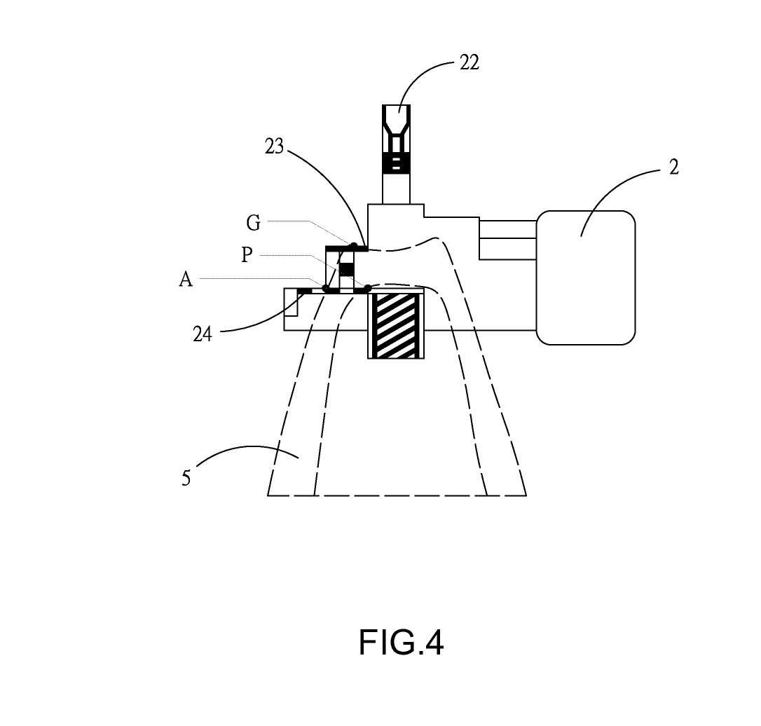

Furthermore, when the dental implant platform positioning ruler 2 is used to measure and configure the ideal dental implant position on the tooth model 5 (see FIG. 4), the ideal buccal gingival edge (point G) mainly serves as the positioning point and the measurements of the vertical reference portion 23 and the horizontal reference portion 24 are utilized to locate a reference point, which is 3 mm under the point G, and then to locate points A and P, which are 3˜4 mm away from the reference point in two opposite directions parallel to the horizontal reference portion 24 (the point G is the ideal gum edge, the point A is the outer side of the buccal side gum, and the point P is the most buccal side of the dental implant platform). Then, the resin material can be used to connect the connecting fixing member 3 to the neighboring tooth regions on two sides of the dental implant position, and the drill bit guide 4 is inserted into the connecting fixing member 3, so that the hole satisfying the dental implant position and angle can be drilled through the through hole 42 of the drill bit guide 4.

Indexes are formed on the vertical reference portion 23 and the horizontal reference portion 24 of the dental implant platform positioning ruler 2, so that the point G (ideal gum edge), the point A (the outer side of the buccal side gum) and the point P (the most buccal side of the dental implant platform) can be set according to the relative position between the indexes.

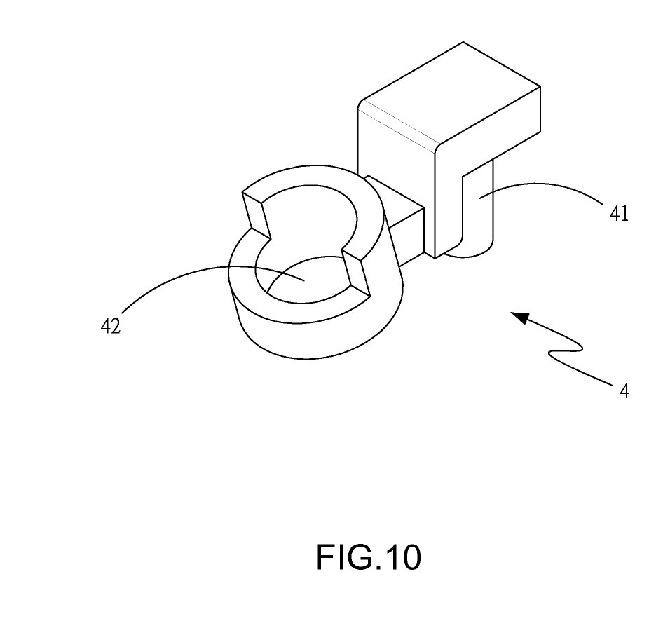

The drill bit guide 4 has different predetermined diameters and buccal lingual side positions. Because the dental implant position may change according to the inclining of the alveolar bone, in addition to the condition that the through hole 42 of the drill bit guide 4 is parallel to the projecting member 41, as shown in the drawing, the through hole 42 may be inclined with respect to the projecting member 41 (not parallel to the projecting member 41), as shown in FIG. 10, so that the through hole 42 with a different angle can be used in conjunction with the dental implant position with a different angle after measurement and layout. The angle of the through hole 42 is not particularly restricted, and may be 15°, 20° or 25°, wherein the drill bit guide 4 with the different angle of the through hole 42 is mainly replaced according to the requirement of the dental implant angle.

Basically, in the drill bit guiding device 1 for dental implant surgery, the dental implant platform positioning ruler 2, the connecting fixing member 3 and the drill bit guide 4 are used in conjunction with one another, so that the three members are indispensable. In order to facilitate the carry and storage, the dental implant platform positioning ruler 2, the connecting fixing member 3 and the drill bit guide 4 may be configured to be separated, and the procedure of the dental implant surgery can be performed after the layout is ready and the three members are assembled.

In summary, compared with the conventional dental implant surgery that causes various drawbacks and inconvenience, the drill bit guiding device 1 for dental implant surgery of the invention is provided so that the dental implant platform positioning ruler 2, the connecting fixing member 3 and the drill bit guide 4 can be used in conjunction with one another to precisely and easily measure and configure the ideal dental implant position, wherein the drill bit guide 4 satisfying the dental implant angle can be replaced according to the different dental implant angle.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A drill bit guiding device for dental implant surgery, the drill bit guiding device comprising:
a dental implant platform positioning ruler having a fixing portion, a protrusion and a vertical reference portion and a horizontal reference portion for measurement;
a connecting fixing member having a slot, wherein the other end of the slot is formed with an insertion portion, each of two corresponding sides of the connecting fixing member is formed with an extension, and the connecting fixing member is embedded into the fixing portion of the dental implant platform positioning ruler through the insertion portion;
a drill bit guide having a projecting member and a through hole, wherein the drill bit guide may be inserted into the slot of the connecting fixing member through the projecting member;
an ideal dental implant placement position is mainly firstly configured on a tooth model through the dental implant platform positioning ruler, then the connecting fixing member is embedded into the dental implant platform positioning ruler, and a resin material is used to connect the extensions of the connecting fixing member to neighboring teeth on two sides of a dental implant position, and finally the connecting fixing member and the resin material are removed and placed on an oral gum to be treated, and the drill bit guide is inserted into the connecting fixing member, so that a hole satisfying the ideal dental implant position and angle is drilled at the dental implant position through the through hole of the drill bit guide.

2. The drill bit guiding device according to claim 1, wherein indexes are formed on the vertical reference portion and the horizontal reference portion of the dental implant platform positioning ruler.

3. The drill bit guiding device according to claim 1, wherein a grip portion is disposed on an outer side of the slot of the connecting fixing member.

4. The drill bit guiding device according to claim 1, wherein a plurality of fixing protrusions is formed on each of the extensions on the two corresponding sides of the connecting fixing member.

5. The drill bit guiding device according to claim 1 wherein the through hole of the drill bit guide is a three-quarter scaled cylindrical structure.

6. The drill bit guiding device according to claim 1, wherein the through hole of the drill bit guide may be parallel to the projecting member.

7. The drill bit guiding device according to claim 1, wherein the through hole of the drill bit guide may be inclined with respect to the projecting member.
